(19) United States
(12) Patent Application Publication
(10) Pub. No.: US 2023/0257897 A1
(43) Pub. Date: Aug. 17, 2023

(54) CORROSION-RESISTANT TERMINAL MATERIAL FOR ALUMINUM CORE WIRE, METHOD FOR MANUFACTURING SAME, CORROSION-RESISTANT TERMINAL, AND ELECTRIC WIRE TERMINAL STRUCTURE

(71) Applicant: MITSUBISHI MATERIALS CORPORATION, Tokyo (JP)

(72) Inventors: Takashi Tamagawa, Aizuwakamatsu-shi (JP); Kenji Kubota, Naka-shi (JP)

(73) Assignee: MITSUBISHI MATERIALS CORPORATION, Tokyo (JP)

(21) Appl. No.: 18/012,339

(22) PCT Filed: Jun. 16, 2021
(86) PCT No.: PCT/JP2021/022808

§ 371 Date: Dec. 22, 2022

(30) Foreign Application Priority Data
Jun. 26, 2020 (JP) 2020-110986

(51) Int. Cl. C25D 5/10; C25D 3/60; C25D 3/56; C25D 5/48; C25D 7/06; H01R 4/18

(52) U.S. Cl. CPC C25D 5/10; C25D 3/60; C25D 3/565; C25D 5/48; C25D 7/0607; H01R 4/183

(57) ABSTRACT

A corrosion-resistant terminal material for an aluminum core wire having a good adhesion of plating and a high effect of corrosion resistant, having a base material in which at least a surface is made of copper or copper alloy and a corrosion-resistant film formed on at least a part of the base material; the corrosion film having an intermediate alloy layer made of tin alloy, a zinc layer made of zinc or zinc alloy formed on the intermediate alloy layer, and a tin-zinc alloy layer made of tin alloy containing zinc and formed on the zinc layer; and a tin content in the intermediate alloy layer is 90 at % or less.

### BACKGROUND OF THE INVENTION

### Technical Field

The present invention relates to a corrosion-resistant terminal material having a high corrosion prevention effect as a terminal to be crimped to a terminal end of an electric wire made of an aluminum core wire, a method for manufacturing the same, a corrosion terminal made of the terminal material, and an electric wire terminal structure using the terminal. Priority is claimed on Japanese Patent Application No. 2020-110986, filed Jun. 26, 2020, the content of which is incorporated herein by reference.

### Background Art

Conventionally, an electric wire is connected to a device by crimping a terminal configured from copper or copper alloy on a terminal end part of the electric wire configured from copper or copper alloy and connecting this terminal on a terminal provided at the device. Further, in order to reduce the weight of the electric wire, a core wire of the electric wire may be made of aluminum or aluminum alloy instead of copper or copper alloy.

For example, Patent Literature 1 discloses an aluminum electric wire made of aluminum alloy for a vehicle wire harness.

When the electric wire (conductive wire) is configured of aluminum or aluminum alloy and the terminal is configured of copper or copper alloy, electrolytic corrosion by a potential difference of different metals may occur if water enters in a crimping part of the terminal and the electric wire. Furthermore, due to the corrosion of the electric wire, an electric resistance may be increased at an electric resistance or a crimping force may be decreased in the crimping part.

For example, Patent Literature 2 describes a prevention method of this corrosion.

Patent Literature 2 discloses a terminal-end structure of a wire harness in which a crimping part formed at one end of a terminal fitting is crimped along an outer periphery of a covered portion of a covered electric wire in a terminal region of a covered electric wire, and at least an end portion exposed region of the crimping part and an entire outer periphery of a region in the vicinity thereof are completely covered with a molding resin.

However, this method requires a step of resin-molding after the terminal processing, and the number of work steps is increased, so that the productivity is reduced and the manufacturing cost is increased. Furthermore, there is a problem in that downsizing of the wire harness is prevented due to increase of a cross-sectional area of the terminal by the resin.

On the other, for example, Patent Literature 3, Patent Literature 4, and Patent Literature 5 describe to using a surface treatment method as an anti-corrosion method including no additional step after the terminal processing.

A terminal material described in Patent Literature 3 has a base material made of copper or copper alloy, a contact characteristic film formed on the base material, and an corrosion-resistant film formed on a part of the contact characteristic film in which a first tin layer made of tin or tin alloy which is reflow-treated is formed on a surface. In the corrosion-resistant film, a zinc-nickel alloy layer containing zinc and nickel, a second tin layer made of tin or tin alloy formed on the zinc-nickel alloy layer, and a metal-zinc layer formed on the second tin layer are laminated in this order on the contact characteristic film.

A terminal material described in Patent Literature 4 is an Sn-plated material in which an Sn-contained layer is formed on a base material made of copper or copper alloy, the Sn-contained layer is configured of a Cu—Sn alloy layer and an Sn layer made of Sn formed on a surface of the Cu—Sn alloy layer with a thickness 5 μm or less, an Ni-plated layer is formed on a surface of the Sn-contained layer, and a Zn-plated layer is formed on a surface of the Ni-plated layer as an outermost layer.

It is necessary to both achieve a connection reliability of the terminal contact and an anti-corrosion property of the crimping part of the electric wire, so that the tin-plated material having the tin layer on the surface is formed on the terminal contact part and the zinc layer is formed on the tin layer in the electric wire crimped part.

In the electric wire crimped part, since the formed zinc layer is near to aluminum in corrosion potential of metal zinc, the electrolytic corrosion when in contact with the core wire made aluminum can be restrained.

Whereas, the contact reliability may be deteriorated under corrosion environment such as high temperature, high humidity, corrosion gas and the like if a metal-zinc layer exists on the surface of the tin layer. Accordingly, in order to enable to restrain the increase of the contact resistance even when it is exposed in the corrosion environment, the part where the corrosion-resistant film is not formed is made to be a contact characteristic film having the first tin layer on the surface.

However, since adhesion between the zinc layer and the tin layer is not good, in order to improve the adhesion, in both Patent Literatures 3 and 4, the surface of the tin layer is degreased and activated, and then nickel strike plating is performed on the tin layer.

Since the oxide of tin obstructs the adhesion to the zinc layer, surface-activation treatment or activation (removal of an oxide film of tin) treatment of a surface of nickel (strike) plating is carried out.

In order to improve the adhesion between the zinc layer and the tin layer, in a terminal material described in Patent Literature 5, on a surface of a plate material made of copper or copper alloy material having a tin layer as an outermost layer is subjected to a blast treatment step performing a blast treatment with a treated area rate becomes 75% or more and so that arithmetic mean estimation Ra becomes 0.2 μm or more and 3.0 μm or less, and a thermal spraying step forming a Zn or Zn alloy layer by thermal spraying on a surface of the Sn layer on which the blast treatment is performed to have 5 μm or more and 80 μm or less of an average thickness to produce.

### CITATION LIST

### Patent Literature

[Patent Literature 1] Japanese Unexamined Patent Application, First Publication No. 2004-134212

[Patent Literature 2] Japanese Unexamined Patent Application, First Publication No. 2011-222243

[Patent Literature 3] Japanese Unexamined Patent Application, First Publication No. 2019-11503

[Patent Literature 4] Japanese Unexamined Patent Application, First Publication No. 2018-90875

[Patent Literature 5] Japanese Unexamined Patent Application, First Publication No. 2018-59147

### SUMMARY OF INVENTION

### Technical Problem

By these methods, there is concern that the zinc layer on the tin layer may be peeled off if the surface activation treatment and the blast treatment are not sufficient.

The present invention is achieved in consideration of the above problem, and has an object to provide a corrosion resistant material for an aluminum core wire having a good adhesion of plating even when the zinc layer is laminated on the tin alloy layer.

### Solution to Problem

A corrosion-resistant terminal material for an aluminum core wire according to the present invention has a base material at least a surface of which is made of copper or copper alloy, and a corrosion-resistant film formed on at least a part of the base material; the corrosion-resistant film has an intermediate alloy layer made of tin alloy, a zinc layer made of zinc or zinc alloy formed on the intermediate alloy layer, and a tin-zinc alloy layer made of tin alloy containing zinc formed on the zinc layer; and the intermediate alloy layer has a tin content of 90 at % or less.

The corrosion-resistant terminal material contains zinc in the tin-zinc alloy layer on the surface, and has the zinc layer under the tin-zinc alloy layer, and since the corrosion potential of zinc is closer to aluminum than tin, it is possible to restrain the occurrence of the electrolytic corrosion when the corrosion-resistant terminal material comes into contact with the aluminum core wire.

In addition, since the zinc layer is directly formed on the intermediate alloy layer without interposing a tin layer, the adhesion between the intermediate ally layer and the zinc layer is good, and the peeling can be prevented even when the terminal is subjected to severe processing. In this case, if the content of tin in the intermediate alloy layer exceeds 90 at %, a tin oxide film is likely to be formed when the intermediate alloy layer, and the zinc layer formed thereon is easily peeled off. The content of tin in the intermediate alloy layer is more preferably 65 at % or less.

For the zinc layer, other than pure zinc, alloy containing cobalt, nickel, iron, and molybdenum adding to zinc can be adopted; a nickel-zinc alloy layer is suitable.

In the corrosion-resistant terminal material for an aluminum core wire, the intermediate alloy layer can be a copper-tin alloy layer or a nickel-tin alloy layer.

In the corrosion-resistant terminal material for an aluminum core wire, it is preferable that an intermediate nickel layer made of nickel or nickel alloy be formed between the intermediate alloy layer and the zinc layer.

The intermediate nickel layer interposed between the intermediate alloy layer and the zinc layer further improves the adhesion of the zinc layer.

In the corrosion-resistant terminal material for an aluminum core wire, a content per unit area of tin in the whole of the tin-zinc alloy layer and the zinc layer is 0.5 mg/cm² or more and 7.0 mg/cm², and a content per unit area of zinc is 0.07 mg/cm² or more and 2.0 mg/cm² or less.

If the content per unit area of tin is less than 0.5 mg/cm², the zinc layer is partially exposed when processing, and the contact resistance may be increased. If the content per unit area of tin exceeds 7.0 mg/cm², the diffusion of zinc to the surface is not sufficient, and the corrosion current value becomes high. If the content per unit area of zinc is less than 0.07 mg/cm², the amount of zinc is insufficient and the corrosion current value tends to be high; and if it exceeds 2.0 mg/cm², the amount of zinc is too large and the contact resistance tends to be high.

In the corrosion-resistant terminal material for an aluminum core wire, the corrosion-resistant film may be provided on a part of the base material and a first film may be provided on a part where the corrosion-resistant film is not provided, the first film may have the intermediate alloy layer and a first tin layer made of tin or tin alloy having a different composition from the intermediate alloy layer formed on the intermediate alloy layer on the base material. In this case, the corrosion-resistant film does not have the first tin layer on the intermediate alloy layer.

Since the first film is made of the soft first tin layer at the surface and the intermediate alloy layer made of hard tin alloy under the first tin layer, the electrical connection property is excellent as a contact.

A corrosion-resistant terminal for an aluminum core wire of the present invention is made of any of the above-described corrosion-resistant terminal materials for an aluminum core wire. In an electric wire terminal structure of the present invention, the corrosion-resistant terminal for an aluminum core wire is crimped to a terminal of an electric wire made of aluminum or aluminum alloy.

A method for manufacturing a corrosion-resistant terminal material includes a first film forming step by laminating a plurality of plating layers on a base material in which at least a surface is made of copper or copper alloy and subjected to an alloying step, forming a first film having an intermediate alloy layer made of tin alloy and a first tin layer made of tin or tin alloy having a different composition from the intermediate alloy layer a tin layer removal step removing the first tin layer in the first film, and a corrosion-resistant film forming step forming a zinc layer made of zinc or zinc alloy and a second tin layer made of tin or tin alloy in order on the intermediate alloy layer after the first tin layer is removed.

Since the second tin layer formed on the zinc layer becomes a tin-zinc alloy layer by diffusion of zinc from the zinc layer, it is possible to restrain the occurrence of the electrolytic corrosion when it comes into contact with the aluminum core wire.

Moreover, since the zinc layer is directly formed on the intermediate alloy layer made of tin alloy, the adhesion between them is excellent.

In this case, after forming the intermediate alloy layer and the first tin layer by the alloying step after a plurality of the plating treatments, only necessary parts of the first tin layer are removed to form the zinc layer and the second tin layer, so that the film (the first film) that is excellent in the electric characteristic as a contact and the corrosion-resistant film (the second film) that is a part in contact with the aluminum core wire can be formed in order to be reasonable. The alloying step is a heat treatment or a treatment leaving at normal temperature for a predetermined time, to easily form.

In the method of manufacturing a corrosion-resistant terminal material for an aluminum core wire, in the corrosion-resistant film forming step, a part of the first tin layer is removed, and a surface of a part where the first tin layer is not removed is maintained in a state in which a surface of the first film is exposed.

The part where the first tin layer is remained is made of the soft first tin layer at the surface and has the hard intermediate alloy layer under the first tin layer, the electric contact characteristic is excellent as a contact.

In addition, in any method for manufacturing, a heat treatment at some temperature for some time may be performed in order to promote mutual diffusion between zinc in the zinc layer and tin in the second tin layer.

### Advantageous Effects of Invention

According to the present invention, it is possible to provide a corrosion-resistant terminal material having the good adhesion of plating and high effect of preventing corrosion.

### BRIEF DESCRIPTION OF DRAWINGS

FIG. 1 It is a cross-sectional view schematically showing a first embodiment of a corrosion-resistant terminal material of the present invention.

FIG. 2 It is a plan view of the corrosion-resistant terminal material of the embodiment.

FIG. 3 It is a perspective view showing an example of a terminal on which the corrosion-resistant terminal material of the embodiment is adopted.

FIG. 4 It is a frontal view showing a terminal of an electric wire on which the terminal of FIG. 3 is crimped.

FIG. 5 It is a cross-sectional view showing a state in which a first film is formed while manufacturing in the corrosion-resistant terminal material of the first embodiment.

FIG. 6 It is a cross-sectional view showing a state in which a part of a tin layer is removed from a state shown in FIG. 5.

FIG. 7 It is a cross-sectional view schematically showing a second embodiment of the corrosion-resistant terminal material of the present invention.

FIG. 8 It is a cross-sectional view showing an example in which an intermediate alloy layer in FIG. 1 is replaced by an uneven copper-tin alloy layer.

FIG. 9 It is a cross-sectional view showing an example in which the intermediate alloy layer in FIG. 1 is replaced by a nickel-tin alloy layer parts of which enters as projections into a zinc layer and a first tin layer.

### DESCRIPTION OF EMBODIMENTS

A corrosion-resistant terminal material and a method of manufacturing thereof, a corrosion-resistant terminal and an electric wire terminal structure of embodiments of the present invention will be explained.

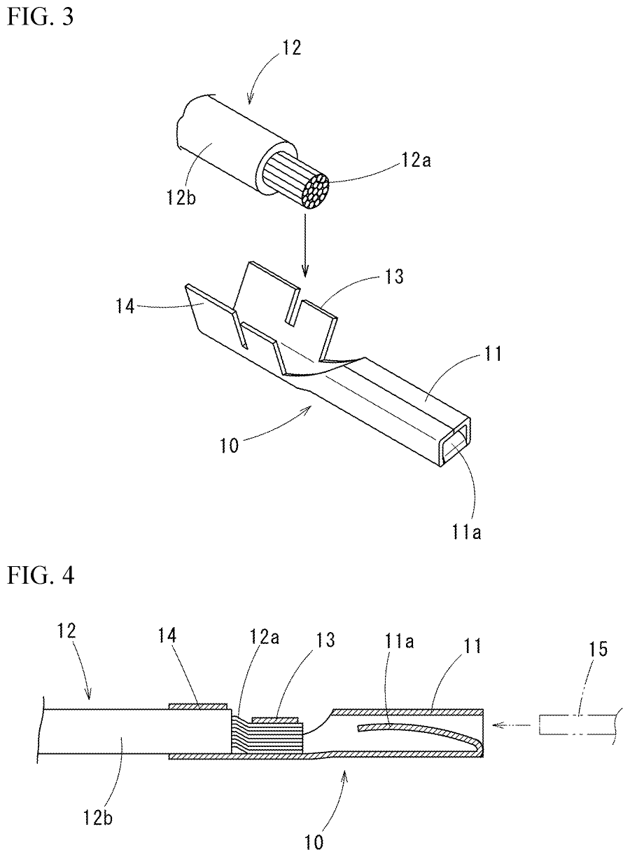

A corrosion-resistant terminal material 1 for an aluminum core wire (hereinafter, simply denoted a corrosion-resistant terminal material) of the present embodiment is a strip material formed into a belt-plate shape for forming a plurality of terminals, as wholly shown in FIG. 2; between a pair of long belt-shaped carrier parts 21 extending in parallel, a plurality of terminal members 22 to be formed into terminals are arranged with intervals in a longitudinal direction of the carrier parts 21, and the terminal members 22 are connected to both carrier parts 21 via narrow connection parts 23. The terminal members 22 are formed into a shape shown in FIG. 3 for example, and finished as a corrosion-resistant terminal 10 by being cut off from the connection parts 23.

The corrosion-resistant terminal 10, showing a female terminal in an example of FIG. 3, in which a coupling part 11 into which a male terminal 15 is fit-inserted (refer to FIG. 4), a core-wire crimping part 13 to which an exposed core wire (aluminum core wire) 12a of an electric wire 12 is crimped, and a cover-crimping part 14 to which a covering part 12b of the electric wire 12 is crimped are arranged in this order from a tip, and formed integrally. The coupling part 11 is formed into a square-tube shape; a spring piece 11a connected to the tip is fold and inserted inside (refer to FIG. 4).

FIG. 4 shows a terminal structure in which the corrosion-resistant terminal 10 is crimped to the electric wire 12.

In the strip material shown in FIG. 2, portions which become the core-wire crimping part 13 when the corrosion-resistant terminal 10 is formed and peripheral portions thereof are a core-wire contact part 26.

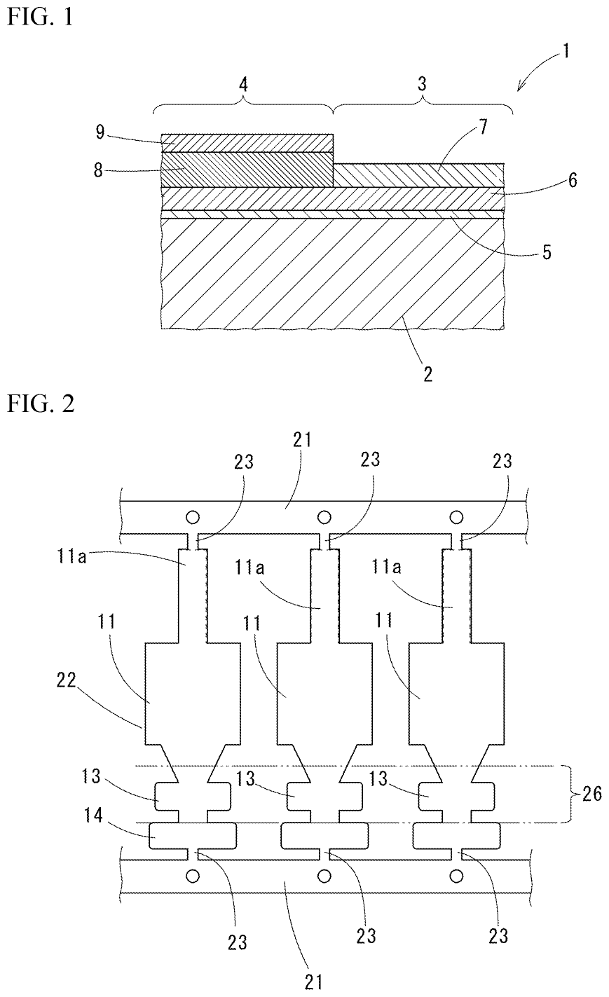

In the corrosion-resistant terminal material 1, as schematically showing the cross section in FIG. 1, a film is formed on a base material 2 of which at least a surface is made of copper or copper alloy.

The base material 2 is not particularly limited in the composition if the surface is made of copper or copper alloy. In the present embodiment, the base material 2 is configured from a plate material made of copper or copper alloy; however, it may be configured from a plated material in which copper plating or copper-alloy plating is carried out on a surface of a mother material. As the mother material made of copper or copper alloy, oxygen-free copper (C10200), Cu—Mg type copper alloy (C18665 ) and the like may be applied.

On the surface of the base material 2, a base layer 5 made of nickel or nickel alloy is formed on the entire surface. The base layer 5 has a function of preventing the diffusion of copper from the base material 2 to the film and serves for improving thermal resistance. An average thickness of the base layer 5 is, for example, 0.1 μm or more and 5.0 μm or less; and a nickel content percentage is 80% by mass or more. If the average thickness of the base layer 5 is less than 0.1 μm, the effect of preventing the diffusion of copper is poor; and if it exceeds 5.0 μm cracks easily occur while press-working.

More preferably, the average thickness of the base layer 5 is 0.2 μm or more and 2.0 μm or less.

If the nickel content percentage is less than 80% by mass, the effect of preventing the diffusion of copper is small. More preferably, the nickel content percentage of the base layer 5 is 90 % by mass or more. In addition, the base layer 5 is not necessarily necessary in accordance with usage environment or the like.

In the film (the surface of the base material 2), on parts other than the core-wire contact parts 26, a first film 3 is formed. The first film 3 of the present embodiment has an intermediate alloy layer 6 made of tin alloy formed on the base layer 5, and a tin layer (first tin layer) 7 made of tin or tin alloy having a different composition from the intermediate alloy layer formed on the intermediate alloy layer 6.

For the intermediate alloy layer 6, copper-tin alloy, nickel-tin alloy, iron-tin alloy, cobalt-tin alloy and the like can be used. Since the soft tin layer 7 is held on the intermediate alloy layer 6, the friction coefficient is restrained low as a connector terminal. Tin whiskers are not easily generated in the first film 3 by releasing internal strain of the tin layer by a reflow treatment.

A tin content in the intermediate alloy layer 6 is 90 at % or less. If the tin content exceeds 90 at %, tin-oxide film is easily generated when the tin alloy layer is formed, so that a zinc layer formed thereon is easily peeled off. The tin content is more preferably 65 at % or less. Although a lower limit is not particularly limited, 10 at % is preferable, and more preferably, 20 at %.

An average thickness of the intermediate alloy layer 6 is preferably 0.05 μm or more and 3.0 μm or less. If the average thickness of the intermediate alloy layer 6 is too thin due to a lack of alloying treatment, the internal stress of the tin layer 7 cannot be released sufficiently, and the tin whiskers are easily generated. On the other, if the average thickness of the intermediate alloy layer 6 is too thick, cracks easily occur while processing.

An average thickness of the tin layer (the first layer) 7 is preferably 0.1 μm or more and 5.0 μm or less. If the average thickness of the tin layer 7 is too thin, there is a concern that solder wettability and the contact resistance may be deteriorated.

A second film (corrosion-resistant film) 4 is formed on the core-wire contact part 26. In the second film 4, the tin layer 7 on the surface of the first film 3 is not formed, but a zinc layer 8 made of zinc or zinc alloy and a tin-zinc alloy layer 9 made of tin alloy containing zinc are piled on the intermediate alloy layer 6 in order. Zinc in the tin-zinc alloy layer 9 is by diffusing zinc from the zinc layer 8.

The zinc layer 8 is a layer made of pure zinc or a layer made of zinc alloy containing one or more of nickel, iron, manganese, molybdenum, cobalt, cadmium, and lead as additive elements. By containing these additive elements to form zinc alloy, the corrosion resistance can be improved.

These additive elements also have an effect of preventing excessive diffusion of zinc into the tin-zinc alloy layer 9 on the zinc layer 8. Furthermore, also when the tin-zinc alloy layer 9 disappears by being exposed in the corrosive environment, it is possible to continuously maintain the zinc layer 8 for a long time and prevent the increase of the corrosion current. Among the additive elements, nickel-zinc alloy containing nickel is especially preferable since it has high effect of improving the corrosion resistance.

The content of tin per unit area contained in the whole layers of the zinc layer 8 and the tin-zinc alloy layer 9 is 0.5 mg/cm² or more and 7.0 mg/cm² or less; and the content of zinc per unit area is 0.07 mg/cm² or more and 2.0 mg/cm² or less.

If the content of tin per unit area is less than 0.5 mg/cm², there is concern for partially exposure of zinc while processing to increase the contact resistance. If the content of tin per unit area exceeds 7.0 mg/cm², the diffusion of zinc to the surface is insufficient and the corrosion current value is high. A preferable range of the content of tin per unit area is 0.7 mg/cm² or more and 2.0 mg/cm² or less.

If the content of zinc per unit area is less than 0.07 mg/cm², the amount of zinc is insufficient and the corrosion current value tends to be high; and if it exceeds 2.0 mg/cm², the amount of zinc is too large and the contact resistance tends to be high.

In addition, the content percentage of zinc contained in the tin-zinc alloy layer 9 is preferably 0.2% by mass or more and 10% by mass or less.

Regarding the additive elements in the zinc layer 8, the content per unit area contained in the whole layer of the zinc layer 8 and the tin-zinc alloy layer 9 is preferably 0.01 mg/cm² or more and 0.3 mg/cm² or less. If the content of the additive elements per unit area is less than 0.01 mg/cm², the effect of restraining the diffusion of zinc is poor; if it exceeds 0.3 mg/cm², the diffusion of zinc is insufficient and the corrosion current may be high.

In addition, the content of zinc per unit area described above is preferably in a range of one time or more and 10 times or less of the content of the additive elements per unit area. By making the relationship in this range, the occurrence of whiskers can be further restrained.

The second film 4 with the structure as above has the corrosion potential to a silver-silver chloride electrode of −500 mV or less and −900 mV or more (−500 mV to −900 mV) and has an excellent corrosion-resistant effect since the corrosion potential of aluminum is −700 mV or less and −900 mV or more.

Next, a method for manufacturing the corrosion-resistant terminal material 1 will be described.

The method for manufacturing the corrosion-resistant terminal material 1 has a first film forming step forming the first film 3 on the base material 2, a tin layer removal step removing a part of the tin layer (the first layer) 7 that is a surface layer among the first film, and a corrosion-resistant film forming step forming the second film (the corrosion-resistant film) 4 on the part where the tin layer 7 is removed.

In this case, a plate material made of copper or copper alloy is prepared as the base material 2, and formed into a shape of the terminal material 1 with a belt-plate shape in which a plurality of the terminal members 22 are connected to the carrier parts 21 via the connection parts 23, as shown in FIG. 2, by carrying out the press process such as cutting, punching and the like after the first film forming step. Then, after cleansing the surface of the terminal material 1 by degreasing, the tin layer removal step is carried out, and the corrosion-resistant film forming step is carried out.

### [First Film Forming Step]

The base layer 5 is formed by nickel plating made of nickel or nickel alloy.

The nickel plating is not particularly limited if a dense nickel-based film, and can be formed by electroplating using well-known the Watts bath, a sulfamate bath, a citric acid bath, or the like. Considering press bendability and barrier property to copper of the corrosion-resistant terminal 10, pure nickel plating obtained by the sulfamate bath is desirable.

Regarding the intermediate alloy layer 6 and the tin layer (first tin layer) 7, in a case in which the intermediate alloy layer 6 is made of copper-tin alloy, on the base layer 5, 25 copper plating made of copper or copper alloy and tin plating made of tin or tin alloy are carried out in order, and then the alloying treatment such as reflow treatment is carried out to be formed.

As the copper plating, a general copper plating bath may be used: for example, copper sulfate bath containing copper sulfate (CuSO₄) and sulfuric acid (H₂SO₄) as main ingredients can be used.

As the tin plating, a general tin plating bath may be used: for example, sulfate acid bath containing sulfuric acid (H2SO4 ) and stannous sulfate (SnSO4) as main ingredients can be used.

The reflow treatment is carried out by raising the surface temperature of the base material 2 to 240° C. or more and 360° C. or less, holding this temperature for one second or more and 12 seconds or less, and then rapidly cooling.

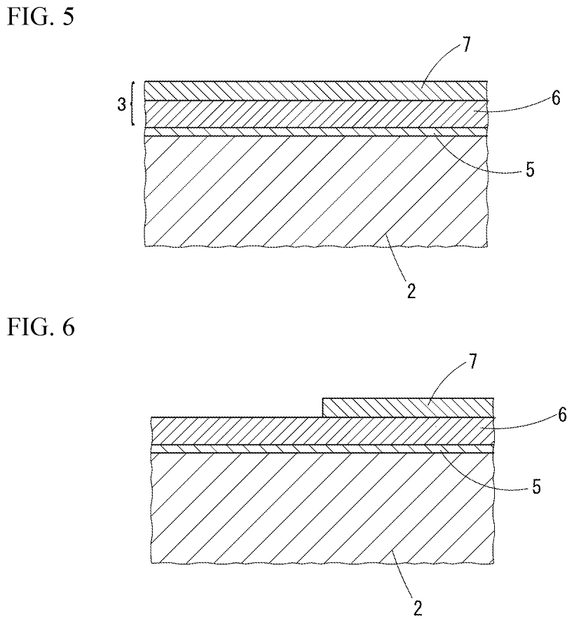

As a result, as shown in FIG. 5, the first film 3 is formed on the whole surfaces (both front and back surfaces) of the base material 2.

On the other, in a case in which the intermediate alloy layer 6 is made of nickel-tin alloy, a nickel-plating layer made of nickel or nickel alloy and a tin-plating layer made of tin or tin alloy are formed in order on the surface of the base material 2, then the reflow treatment is carried out to be formed. The nickel-plating layer is the same as the above-described base layer 5; the base layer 5 is not formed, forming the nickel-plating layer and the tin-plating layer, and then carrying out the reflow treatment for example, as the alloying treatment. In a case of forming the base layer 5, the nickel layer may be formed in a thickness so as to remain as the base layer 5 after the nickel-tin alloy layer is formed.

The reflow treatment is the same as in the case in which the intermediate alloy layer made of copper-tin alloy is formed.

### [Tin Layer Removal Step]

Next, in the terminal material 1 in which the first film 3 is formed, a portion to be the contact to the other terminal (in a case of the female terminal shown in FIG. 4, a portion to be the contact to the male terminal) is covered with a mask (not illustrated).

Then, a portion exposed from the mask is removed of the tin layer 7.

In order to improve the adhesion of the zinc layer 8 formed after this, it is necessary to remove an oxide film of tin obstructing the adhesion; accordingly, the tin layer 7 is removed together with the tin oxide in chemical polishing treatment.

As a method of removing the tin layer 7, for example, the chemical polishing treatment is used. A chemical polishing solution used for the chemical polishing treatment is not particularly limited if it can remove the tin layer 7. Treatment condition is also not limited and may appropriately be adjusted in accordance with the type of the used chemical polishing solution and the like.

As the chemical polishing solution, for example, mixed solution made of sulfuric acid and hydrogen peroxide as main ingredients can be used.

FIG. 6 shows a state in which a part of the tin layer 7 is removed.

### [Corrosion-Resistant Film Forming Step]

Next, the surface of the part where the tin layer 7 is removed is cleansed, and zinc plating and tin plating are carried out in order. The intermediate alloy layer 6 is exposed at the part where the tin layer 7 is removed, the oxide film is drastically smaller in comparative with the case of the tin layer 7 even if it is generated on the surface; however, in order to improve the adhesion with the zinc layer 8, the surface of the intermediate alloy layer 6 is cleansed by pickling, for example.

As zinc plating or zinc alloy plating for forming the zinc layer 8, it is preferable to treat in an acid plating bath in order to restrain oxidizing the surface of the intermediate alloy layer 6; for example, a sulfate bath can be used. It is possible to form films for the zinc-cobalt alloy plating by the sulfate bath, for the zinc-manganese alloy plating by a sulfate bath containing citric acid, for the zinc-molybdenum plating by the sulfate bath.

The tin plating made of tin or tin alloy for forming the tin-zinc alloy layer 9 can be performed by electroplating using generally known methods; for example, organic acid baths (for example, a phenol sulfonic acid bath, an alkane sulfonic acid bath, or an alkanol-sulfonic acid bath), acidic baths such as a fluoroboric acid bath, a halogen bath, a sulphate bath, a pyrophosphoric acid bath or the like, or alkaline baths such as a potassium bath, a sodium bath, or the like.

By performing the diffusion treatment for diffusing zinc after performing the zinc plating and the tin plating, as shown in FIG. 1, the tin-zinc alloy layer 9 containing zinc is formed on the zinc layer 8.

For the diffusion treatment, for example, it is maintained at temperature of 30° C. or more and 160° C. or less for a time of 30 minutes or more and 60 minutes or less. Since zinc is diffused immediately, it is enough to be exposed in temperature of 30° C. or more for 30 minutes or more. However, if it exceeds 160° C., tin diffuses to the zinc layer 8 side contrarily to obstruct the diffusion of zinc, the temperature is 160° C. or less.

Then, the terminal member 22 is processed into the shape of the terminal shown in FIG. 3 as it is in the band-plate shape by press working or the like, and the connection parts 23 are cut, so it is formed in the corrosion-resistant terminal 10.

FIG. 4 shows a terminal structure in which the corrosion-resistant terminal 10 is crimped to the electric wire 12; the vicinity of the core-wire crimping part 13 is in directly contact with the core wire 12a of the electric wire 12.

The corrosion-resistant terminal 10 can prevent the electrolytic corrosion even in a state of being crimped to the aluminum core wire 12a, since the tin-zinc alloy layer 9 is formed on the zinc layer 8 in the core-wire contact part 26, and the corrosion potential of zinc is very close to aluminum.

On the other, on the portion where becomes the contact, the tin layer 7 is formed on the intermediate alloy layer 6. In the tin layer 7, the contact resistance can be prevented from increasing even when it is exposed in high temperature, high humidity, and gas corrosion environment. Since the tin layer is subjected to the heat treatment, the tin whiskers can be prevented when it is formed into a connector.

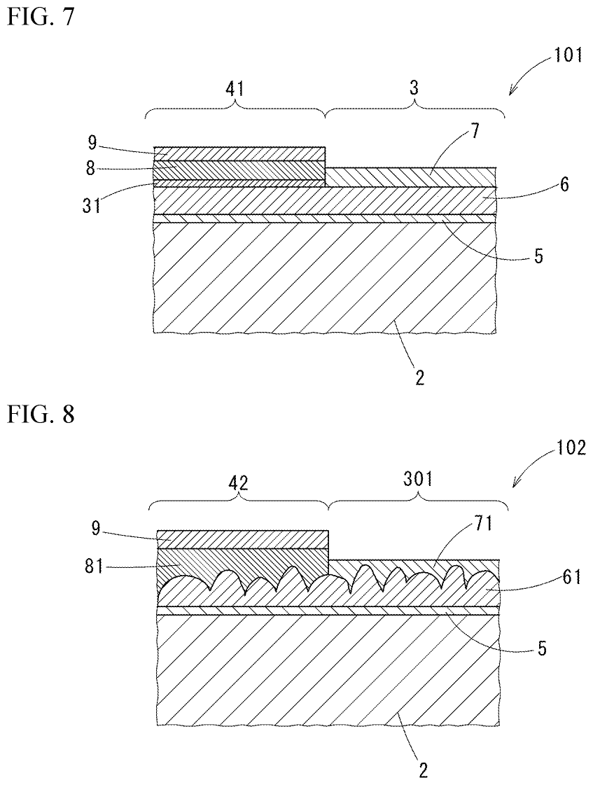

FIG. 7 is a cross-sectional view of a second embodiment of the corrosion-resistant terminal material.

In a corrosion-resistant terminal material 101, an intermediate nickel layer 31 made of nickel or nickel alloy is interposed between the intermediate alloy layer 6 and the zinc layer 8 in a second film (corrosion film) 41. The first film 3 is the same as in the first embodiment.

The intermediate nickel layer 31 works as an adhesion layer to further improve the adhesion between the intermediate alloy layer 6 and the zinc layer 8.

The intermediate nickel layer 31 is formed by performing a nickel-strike plating, a nickel plating, a nickel-strike plating in order as one example.

The nickel-strike plating can be formed by electroplating using a generally known wood bath or the like. In addition, since the nickel-strike plating contains a large amount of hydrogen, it is preferable to form thin so as not to be long time. Moreover, in a case in which the nickel-strike plating is performed on the intermediate alloy layer 6, even if a slight oxide film is formed on the surface of the intermediate alloy layer, it is removed by the nickel-strike plating.

The nickel plating can be formed by electroplating using a known Watts bath, a sulfamic acid bath, a citric acid bath, or the like.

Although the nickel-strike plating is performed twice and the nickel plating is performed once, three times of plating are performed in total, a nickel-strike plating layer formed by the nickel-strike plating cannot recognized as a layer, and is recognized as one integrated as the intermediate nickel layer 31 by three plating.

In addition, since the intermediate nickel layer 31 is formed as the adhesion layer, it may be formed of only one nickel-strike plating layer, or it may be formed to have a double layer structure of the nickel-strike plating layer and the nickel-plating layer thereon; however, it is not limited to these.

By forming the intermediate nickel layer 31 as above described, the adhesion between the intermediate alloy layer 6 and the zinc layer 8 is further improved, and the terminal material becomes not to be easily peeled.

In addition, in the example shown in FIG. 1 and the like, a boundary surface between the intermediate alloy layer 6 and the zinc layer 8 is formed to be substantially flat; however, in accordance with the type of the alloy and the alloying step, the boundary surface may be a unique shape different from FIG. 1.

In a corrosion-resistant terminal material 102 shown in FIG. 8, an example is shown in which an intermediate alloy layer (copper-tin alloy layer) 61 is formed of copper-tin alloy and a boundary surface of the intermediate alloy layer 61 to a zinc layer 81 a corrosion-resistant film 42 and a tin layer (first tin layer) 71 of a first film 301 is unevenly formed. In the intermediate alloy layer 61, intermetallic compounds such as Cu₆Sn₅ are formed, Cu₃Sn and the like; by making the temperature higher and the time longer during the alloying treatment, the intermetallic compound is partially grown to form the surface unevenly. By making the boundary surface into this shape, the adhesion to the intermediate alloy layer 61 and the zinc layer 81 is further improved.

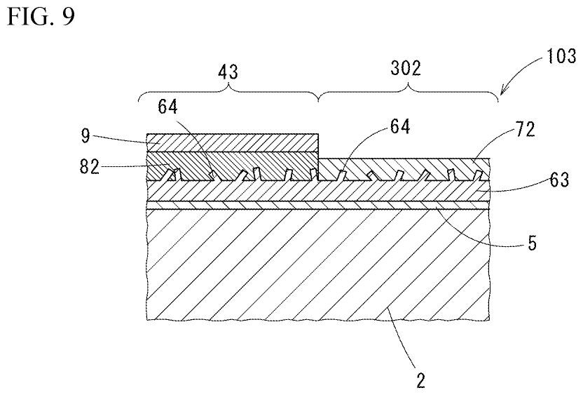

In a corrosion-resistant terminal material 103 shown in FIG. 9, an intermediate alloy layer (nickel-tin alloy layer) 63 is configured of nickel-tin alloy. In the intermediate alloy layer 63, Ni₃Sn₄ is a main ingredient; in a boundary surface of the intermediate alloy layer 63 to a zinc layer 82 of a corrosion-resistant film 43 and a tin layer (first tin layer) 72 of a first film 302, a nickel-tin intermetallic compound 64 which consists of NiSn₄ which is a projection shape extending toward a surface like scales or pins is formed. Since the nickel-tin intermetallic compound 64 is formed to enter the zinc layer 82, the adhesion of them is improved.

The present invention is not limited to the above-described embodiments and various modifications may be made without departing from the scope of the present invention.

For example, although the copper-tin alloy layer and the nickel-tin alloy layer has been exemplified as the intermediate alloy layer, it may be applicable that an iron-tin alloy layer is formed by laminating an iron-plating layer and a tin-plating layer in order and performing alloying treatment (e.g., reflow treatment), or a cobalt-tin alloy layer is formed by laminating a cobalt-plating layer and a tin-plating layer in order and performing alloying treatment (e.g., reflow treatment).

Although the first film 3 is formed on the part to be the contact part to the other terminal and the corrosion-resistant film 4 is formed on the other part from the contact part in the above-described embodiments, it is sufficient that the corrosion-resistant film 4 is formed at least on the part where the core wire 12a of the core-wire contact part 26 is exposed. The present invention includes a structure in which the corrosion-resistant films 4, 41,42, and 43 are formed on the whole surface of the base material 2 but the first films 3, 301, and 302 are not possessed.

### EXAMPLES

A copper plate of C1020 was prepared as the base material 2, and alkaline electrolytic degreasing and pickling were performed on this copper plate; then performing copper plating, nickel plating, and iron plating or cobalt plating; and then performing tin plating and reflow treatment, so that an intermediate alloy layer formed of a copper-tin alloy layer, a nickel-tin alloy layer, iron-tin alloy layer or a cobalt-tin alloy layer, and a tin layer on the intermediate alloy layer were formed.

The tin layer was removed by chemical polishing solution; and after the pickling, pure-zinc plating or zinc-alloy plating was performed on the intermediate alloy layer. In addition, ones in which nickel plating made of nickel or nickel alloy was performed as the base layer between the base material 2 and the intermediate alloy layer were produced.

Moreover, one in which an intermediate nickel layer was formed before zinc plating were produced. The intermediate nickel layer was three types of ones formed only of a nickel-strike plating layer (mentioned as “Ni strike” in tables), ones having a double-layer structure of the nickel-strike plating layer and a nickel-plating layer (mentioned as “Ni plating two layers), and ones having a triple-layer structure of the nickel-strike plating layer, the nickel-plating layer, and the nickel-strike plating layer (mentioned as “Ni plating three layers”).

As Comparative Examples, one in which the tin layer on the intermediate alloy layer (the copper-tin alloy layer or the nickel-tin alloy layer) was not removed and the zinc plating was performed on the tin layer (Comparative Example 1 ) and one in which the tin content in the intermediate alloy layer exceeded 90 at % (Comparative Examples 2 and 3) were produced.

The conditions of the plating and the chemical polishing conditions for removing the tin layer were as followings.

### Chemical Polishing Condition

Composition of Chemical Polishing Solution
   Sulfuric acid: 150 g/L
   Hydrogen peroxide: 15 G/L
Bath Temperature: 30° C.

### Nickel Plating Condition (Base Layer)

Composition of Plating Bath
   Nickel sulfamate: 300 g/L
   Nickel chloride: 35 g/L
   Boric acid: 30 g/L
Temperature of bath: 45° C.
Current density: 5 A/dm²

### Copper Plating Condition

Composition of Plating Bath
   Copper sulfate penta-hydrate: 200 g/L
   Sulfuric acid: 50 g/L
Bath temperature: 45° C.
Current density: 5 A/dm²

### Nickel Plating Condition

Composition of Plating Bath
   Nickel sulfamate: 300 g/L
   Nickel chloride: 35 g/L
   Boric acid: 30 g/L
Temperature of bath: 45° C.
Current density: 5 A/dm²

### Iron Plating Condition

Composition of Plating Bath
   Ferrous chloride tetrahydrate: 300 g/L
   Calcium chloride dihydrate: 300 g/L
Bath temperature: 50° C.
Current density: 2 A/dm²
pH=2

### Cobalt Plating Condition

Composition of Plating Bath
   Cobalt sulfate heptahydrate: 300 g/L
   Sodium chloride: 3 g/L
   Boric acid: 6 g/L
Bath temperature: 50° C.
Current density: 2 A/dm²
pH=1.6

### Tin Plating Condition

Composition of Plating Bath
   Tin methane sulfonate: 200 g/L
   Methane sulphonic acid: 100 g/L
   Brightener
Bathe temperature: 25° C.
Current density: 5 A/dm²

### Zinc Plating Condition

Composition of Plating Bath
   Zinc sulfate heptahydrate: 250 g/L
   Sodium sulfate: 150 g/L
   pH=1.2
Bath temperature: 45° C.
Current density: 3 A/dm²

### Zinc-Manganese Alloy Plating Condition

Composition of Plating Bath
   Manganic sulphate monohydrate: 110 g/L
   Zinc sulfate heptahydrate: 50 g/L
   Trisodium citrate: 250 g/L
   pH=5.3
Bath temperature: 30° C.
Current density: 5 A/dm²

### Zinc-Molybdenum Alloy Plating Condition

Composition of Plating Bath
   Hexaammonium heptamolybdate (VI): 1 g/L
   Zinc sulfate heptahydrate: 250 g/L
   Trisodium citrate: 250 g/L
   pH=5.3
Bath temperature: 50° C.
Current density: 5 A/dm²

### Zinc-Nickel Alloy Plating Condition

Composition of Plating Bath
   Nickel sulfate hexahydrate: 180 g/L
   Zinc sulfate heptahydrate: 80 g/L
   Sodium sulfate: 150 g/L
   pH=2
Bath temperature: 50° C.
Current density: 3 A/dm²

### Zinc-iron Alloy Plating Condition

Composition of Plating Bath
   Iron sulfate heptahydrate: 500 g/L
   Zinc sulfate heptahydrate: 500 g/L
   sodium sulfate: 30 g/L
   pH=2
Bath temperature: 50° C.
Current density: 3 A/dm²

### Nickel-Strike Plating Condition

Composition of Plating Bath
   Nickel chloride: 300 g/L
   Hydrochloric acid: 100 ml/L
Bath temperature: 25° C.
Current density: 5 A/dm²
Plating time: 40 seconds

Next, diffusion treatment for diffusing zinc to the tin-zinc alloy layer was performed on the copper plate with plating layers in which the tin layer was removed to make samples. In Example 23, this diffusion treatment was performed at 30° C. for 60 minutes; in Example 24 at 50° C. for 30 minutes; and in Example 26 at 100° C. for 30 minutes. In other Examples and Comparative Examples were at 30° C. for 30 minutes.

Regarding the obtained samples, contents per unit area was measured of zinc, tin, and the additive elements in the zinc layer and the tin-zinc alloy layer were measured. The adhesion was checked by the cross-cut test; and corrosion environment test was performed and the contact resistance was measured.

<Content per Unit Area of Zinc, Tin, and Additive Elements in Zinc Layer and Tin-Zinc Layer>

The contents per unit are of zinc, tin and the additive elements in the zinc layer and the tin-zinc alloy layer were calculated by: cutting a portion in which the concerned layer was formed at a predetermined area out from the sample; dipping in a plating release solution, Stripper L80 made by Leybold Co., Ltd. to melt the zinc layer and the tin-zinc alloy layer; measuring concentration of zinc, tin and the additive elements contained in the dissolution liquid by a high-frequency inductively coupled plasma emission spectrometric analyzer (e.g., SPS3500 DD made by Hitachi High-Tech Science Corporation); and dividing the concentration by the measurement area. In Tables, the contents (mg/cm²) per unit area were denoted next to the respective additive metal elements.

### <Adhesion Test>

Evaluation was performed by the tape testing method according to JIS H 8504. In order to carry out the test strictly, notches were formed on the plated surface by a sharp cutting tool before the tape was attached so that a square two mm on each side, and then tape was attached. After the tape was peeled off, ones in which the plating was stuck to the tape and peeled off from the material were “C”, ones in which the plating was peeled off from the material but a minute peeling (5% or less of the whole) were “B”, and ones in which the plating was not adhered to the tape and was not peeled off were “A”.

### <Contact Resistance Before and After Corrosion Environment Test>

A female terminal was formed in to a 090 type (a name according to a standard of terminal generally used in the automobile trade), a pure aluminum wire material was brought into contact with a surface where the corrosion-resistant film was formed, and in the state of crimping them the contact resistance between the aluminum wire and the terminal was measured by the four-terminal method (electricity current 10 mA); the measurement value at that time was the resistance before the corrosion environment test. After dipping the sample for 24 hours in 23° C. and 5 % of sodium chloride aqueous (salt water) and then leaving it in 85° C. and 85 % RH of high temperature and high humidity environment for 24 hours, the measurement value of the contact resistance after that was the resistance after the corrosion environment test.

Results of these measurements are shown in Tables. In Tables, the CuSn layer in the column of the intermediate alloy layer is the copper-tin alloy layer, the NiSn layer is the nickel-tin alloy layer, the FeSn layer is the iron-tin alloy layer, and the CoSn layer is the cobalt-tin alloy layer.

TABLE 1

| | | INTERMEDIATE | | | | |
|---|---|---|---|---|---|---|
| | BACKING | ALLOY LAYER | | | INTERMEDIATE | |
| | LAYER | | Tin | FIRST | NICKEL LAYER | |
| | THICKNESS | | CONTENT | TIN | | THICKNESS |
| EXAMPLE | (μm) | TYPE | (at %) | LAYER | TYPE | (μm) |
| 1 | 0.5 | NiSn LAYER | 85 | NONE | NONE | — |
| 2 | NONE | CuSn LAYER | 46 | NONE | Ni STRIKE | 0.05 |
| 3 | NONE | FeSn LAYER | 49 | NONE | NONE | — |
| 4 | NONE | CoSn LAYER | 42 | NONE | Ni STRIKE | 0.05 |
| 5 | NONE | CuSn LAYER | 43 | NONE | NONE | — |
| 6 | NONE | CuSn LAYER | 58 | NONE | Ni STRIKE | 0.05 |
| 7 | 0.5 | NiSn LAYER | 57 | NONE | Ni STRIKE | 0.05 |
| 8 | NONE | CuSn LAYER | 49 | NONE | Ni PLATING | 1.00 |
| | | | | | 3 LAYER | |
| 9 | 0.5 | NiSn LAYER | 75 | NONE | Ni PLATING | 2.00 |
| | | | | | 3 LAYER | |
| 10 | 0.5 | NiSn LAYER | 82 | NONE | Ni PLATING | 0.50 |
| | | | | | 2 LAYER | |

TABLE 2

| | | | | | PROPERTY | | |
|---|---|---|---|---|---|---|---|
| | | | | | EVALUATION | | |
| | | | | | | RESISTANCE | |
| | CONTENT IN ZINC LAYER AND | | | | | MEASUREMENT | |
| | TIN-ZINC ALLOY LAYER | | | | | (mΩ) | |
| | | | ADDITIVE | | | BEFORE | AFTER |
| | | | ELEMENT | ADDITIVE | | CORROSION | CORROSION |
| | Tin | Zinc | IN ZINC | ELEMENT | | ENVIRONMENT | ENVIRONMENT |
| EXAMPLE | (mg/cm²) | (mg/cm²) | LAYER | (mg/cm²) | ADHESION | TEST | TEST |
| 1 | 2.0 | 2.0 | Ni | 0.30 | B | 0.9 | 2.3 |
| 2 | 1.5 | 1.0 | Ni | 0.14 | A | 0.7 | 1.0 |
| 3 | 1.6 | 0.5 | Ni | 0.07 | A | 1.0 | 1.9 |
| 4 | 1.4 | 0.6 | Fe | 0.08 | A | 0.9 | 1.6 |
| 5 | 1.3 | 0.5 | Ni | 0.08 | A | 1.0 | 1.8 |
| 6 | 2.9 | 0.8 | Ni | 0.09 | A | 0.8 | 1.1 |
| 7 | 0.7 | 0.5 | Ni | 0.07 | A | 1.1 | 1.3 |
| 8 | 1.1 | 0.6 | Ni | 0.07 | A | 1.0 | 1.3 |
| 9 | 0.5 | 1.2 | Ni | 0.15 | A | 1.1 | 2.2 |
| 10 | 7.0 | 0.6 | Ni | 0.11 | A | 0.8 | 1.0 |

TABLE 3

| | | INTERMEDIATE | | | | |
|---|---|---|---|---|---|---|
| | BACKING | ALLOY LAYER | | | INTERMEDIATE | |
| | LAYER | | Tin | FIRST | NICKEL LAYER | |
| | THICKNESS | | CONTENT | TIN | | THICKNESS |
| EXAMPLE | (μm) | TYPE | (at %) | LAYER | TYPE | (μm) |
| 11 | 0.5 | NiSn LAYER | 89 | NONE | NONE | — |
| 12 | NONE | CuSn LAYER | 45 | NONE | NONE | — |
| 13 | NONE | CuSn LAYER | 52 | NONE | NONE | — |
| 14 | NONE | CuSn LAYER | 43 | NONE | Ni PLATING | 3.00 |
| | | | | | 3 LAYER | |
| 15 | 0.5 | NiSn LAYER | 79 | NONE | NONE | — |
| 16 | NONE | CuSn LAYER | 28 | NONE | Ni PLATING | 0.80 |
| | | | | | 2 LAYER | |
| 17 | 0.5 | NiSn LAYER | 89 | NONE | NONE | — |
| 18 | NONE | CuSn LAYER | 23 | NONE | NONE | — |
| 19 | NONE | CuSn LAYER | 46 | NONE | NONE | — |
| 20 | NONE | CuSn LAYER | 44 | NONE | NONE | — |

TABLE 4

| | | | | | PROPERTY | | |
|---|---|---|---|---|---|---|---|
| | | | | | EVALUATION | | |
| | | | | | | RESISTANCE | |
| | CONTENT IN ZINC LAYER AND | | | | | MEASUREMENT | |
| | TIN-ZINC ALLOY LAYER | | | | | (mΩ) | |
| | | | ADDITIVE | | | BEFORE | AFTER |
| | | | ELEMENT | ADDITIVE | | CORROSION | CORROSION |
| | Tin | Zinc | IN ZINC | ELEMENT | | ENVIRONMENT | ENVIRONMENT |
| EXAMPLE | (mg/cm²) | (mg/cm²) | LAYER | (mg/cm²) | ADHESION | TEST | TEST |
| 11 | 1.5 | 0.07 | Ni | 0.01 | B | 0.9 | 2.5 |
| 12 | 3.0 | 2.0 | Mo | 0.25 | A | 1.0 | 1.3 |
| 13 | 0.6 | 0.3 | Ni | 0.05 | A | 0.8 | 2.6 |
| 14 | 3.0 | 0.4 | Ni | 0.06 | A | 0.9 | 1.5 |
| 15 | 0.2 | 1.2 | Ni | 0.17 | B | 2.3 | 3.7 |
| 16 | 8.0 | 0.7 | Mn | 0.11 | A | 0.8 | 4.2 |
| 17 | 1.6 | 0.05 | Fe | 0.008 | B | 1.2 | 5.1 |
| 18 | 1.3 | 2.5 | Ni | 0.32 | A | 2.2 | 2.9 |
| 19 | 1.4 | 0.9 | Ni | 0.13 | A | 0.9 | 1.3 |
| 20 | 1.5 | 0.8 | Mo | 0.11 | A | 0.8 | 1.0 |

TABLE 5

| | | INTERMEDIATE | | | | |
|---|---|---|---|---|---|---|
| | BACKING | ALLOY LAYER | | | INTERMEDIATE | |
| | LAYER | | Tin | FIRST | NICKEL LAYER | |
| | THICKNESS | | CONTENT | TIN | | THICKNESS |
| EXAMPLE | (μm) | TYPE | (at %) | LAYER | TYPE | (μm) |
| 21 | 0.5 | CuSn LAYER | 37 | NONE | Ni STRIKE | 0.05 |
| 22 | NONE | CuSn LAYER | 55 | NONE | NONE | — |
| 23 | NONE | CuSn LAYER | 80 | NONE | Ni STRIKE | 0.05 |
| 24 | 0.5 | CuSn LAYER | 44 | NONE | NONE | — |
| 25 | NONE | CuSn LAYER | 82 | NONE | NONE | — |
| 26 | NONE | CuSn LAYER | 43 | NONE | NONE | — |
| 27 | 0.5 | CuSn LAYER | 53 | NONE | Ni PLATING | 0.70 |
| | | | | | 3 LAYER | |
| 28 | NONE | CuSn LAYER | 25 | NONE | NONE | — |
| 29 | NONE | CuSn LAYER | 45 | NONE | Ni STRIKE | 0.05 |

TABLE 6

| | | | | | PROPERTY | | |
|---|---|---|---|---|---|---|---|
| | | | | | EVALUATION | | |
| | | | | | | RESISTANCE | |
| | CONTENT IN ZINC LAYER AND | | | | | MEASUREMENT | |
| | TIN-ZINC ALLOY LAYER | | | | | (mΩ) | |
| | | | ADDITIVE | | | BEFORE | AFTER |
| | | | ELEMENT | ADDITIVE | | CORROSION | CORROSION |
| | Tin | Zinc | IN ZINC | ELEMENT | | ENVIRONMENT | ENVIRONMENT |
| EXAMPLE | (mg/cm²) | (mg/cm²) | LAYER | (mg/cm²) | ADHESION | TEST | TEST |
| 21 | 1.0 | 0.4 | Ni | 0.06 | A | 1.1 | 1.5 |
| 22 | 1.6 | 0.5 | Ni | 0.06 | A | 1.2 | 1.4 |
| 23 | 2.5 | 1.0 | Ni | 0.12 | A | 0.8 | 1.1 |
| 24 | 2.8 | 1.2 | Ni | 0.15 | A | 0.8 | 1.1 |
| 25 | 0.9 | 0.5 | Mn | 0.07 | A | 1.1 | 1.6 |
| 26 | 2.9 | 0.7 | Fe | 0.09 | A | 0.7 | 1.0 |
| 27 | 1.3 | 0.6 | NONE | — | A | 1.2 | 1.3 |
| 28 | 1.5 | 0.5 | Ni | 0.07 | A | 0.9 | 1.5 |
| 29 | 1.6 | 0.9 | Ni | 0.12 | A | 1.1 | 1.6 |

TABLE 7

| | | INTERMEDIATE | | | | |
|---|---|---|---|---|---|---|
| | BACKING | ALLOY LAYER | | | INTERMEDIATE | |
| | LAYER | | Tin | FIRST | NICKEL LAYER | |
| COMPARATIVE | THICKNESS | | CONTENT | TIN | | THICKNESS |
| EXAMPLE | (μm) | TYPE | (at %) | LAYER | TYPE | (μm) |
| 1 | NONE | CuSn LAYER | 61 | PRESENCE | NONE | — |
| 2 | NONE | CuSn LAYER | 92 | NONE | NONE | — |
| 3 | NONE | NiSn LAYER | 94 | NONE | NONE | — |

TABLE 8

| | | | | | PROPERTY | | |
|---|---|---|---|---|---|---|---|
| | | | | | EVALUATION | | |
| | | | | | | RESISTANCE | |
| | CONTENT IN ZINC LAYER AND | | | | | MEASUREMENT | |
| | TIN-ZINC ALLOY LAYER | | | | | (mΩ) | |
| | | | ADDITIVE | | | BEFORE | AFTER |
| | | | ELEMENT | ADDITIVE | | CORROSION | CORROSION |
| COMPARATIVE | Tin | Zinc | IN ZINC | ELEMENT | | ENVIRONMENT | ENVIRONMENT |
| EXAMPLE | (mg/cm²) | (mg/cm²) | LAYER | (mg/cm²) | ADHESION | TEST | TEST |
| 1 | 2.2 | 0.8 | NONE | — | C | 1.7 | 8.6 |
| 2 | 1.8 | 1.5 | Ni | 0.22 | C | 2.1 | 9.8 |
| 3 | 1.5 | 2.3 | Mn | 0.31 | C | 1.9 | 11.5 |

As can be seen from the above-described results, in the samples of the Examples of the present invention, the adhesion between the zinc layer and the intermediate alloy layer was good, the contact resistance value was low, and the contact resistance value was maintained low even after the corrosion environment test. Among them, in a case in which the tin content in the intermediate alloy layer was low, the adhesion was better. Also in a case in which the intermediate nickel layer was formed between the intermediate alloy layer and the zinc layer, the adhesion was better.

Furthermore, in the samples in which the tin content of per unit area and the zinc content per unit area were 0.5 mg/cm² to 7.0 mg/cm² and 0.07 mg/cm² to 2.0 mg/cm² respectively in the whole of the tin-zinc alloy layer and the zinc layer, it was confirmed that the contact resistance after the corrosion test can be maintained smaller.

On the other, the adhesion was poor in Comparative Example 1 in which the zinc layer and the tin-zinc alloy layer were formed leaving the first tin layer on the intermediate alloy layer and Comparative Examples 2 and 3 in which the tin content exceeded 90 at % in the intermediate alloy layer.

In addition, the zinc content rate in the tin-zinc alloy layer is preferably 0.2 % by mass or more and 10 % by mass or less. The zinc concentration in the tin-zinc alloy layer can be obtained using an electron probe microanalyzer EPMA (model No. JXA-8530 F) made by JEOL Ltd., by measuring the surface of the sample at acceleration voltage 6.5 V and a beam diameter 30 μm.

### INDUSTRIAL APPLICABILITY

It is possible to provide a corrosion-resistant terminal material for an aluminum core wire having a good adhesion of plating and an excellent corrosion-resistant effect even when a zinc layer is laminated on a tin alloy layer.

### REFERENCE SIGNS LIST

1 Corrosion-resistant terminal material for aluminum core wire
2 Base material
3 First film
4 Second film (Corrosion-resistant film)
5 Base layer
6 Intermediate alloy layer
7 Tin layer (First tin layer)
8 Zinc layer
9 Tin-zinc alloy layer
10 Corrosion-resist terminal
11 Coupling part
12 Electric wire
12a Core wire (Aluminum core wire)
12b Covering part
13 Core-wire crimping part
14 Cover-crimping part
26 Core-wire contact part
31 Intermediate nickel layer
41, 42, 43 Second film (Corrosion-resistant film)
61 Copper-tin alloy layer (Intermediate alloy layer)
63 Nickel-tin alloy layer (Intermediate alloy layer)
64 Nickel-tin intermetallic compound
71, 72 Tin layer (First tin layer)
81, 82 Zinc layer
101, 102 Corrosion-resistant terminal material
10 301, 302 First film

1. A corrosion-resistant terminal material for an aluminum core wire comprising a base material at least a surface of which is made of copper or copper alloy, and a corrosion-resistant film formed on at least a part of the base material, wherein
the corrosion-resistant film comprises
an intermediate alloy layer made of tin alloy,
a zinc layer made of zinc or zinc alloy formed on the intermediate alloy layer, and
a tin-zinc alloy layer made of tin alloy containing zinc formed on the zinc layer, and wherein
the intermediate alloy layer has a tin content of 90 at % or less.

2. The corrosion-resistant terminal material for an aluminum core wire according to claim 1, wherein the intermediate alloy layer is a copper-tin alloy layer.

3. The corrosion-resistant terminal material for an aluminum core wire according to claim 1, wherein the intermediate alloy layer is a nickel-tin alloy layer.

4. The corrosion-resistant terminal material for an aluminum core wire according to claim 1, wherein an intermediate nickel layer made of nickel or nickel alloy is formed between the intermediate alloy layer and the zinc layer.

5. The corrosion-resistant terminal material for an aluminum core wire according to claim 1, wherein
a content per unit area of tin in the whole of the tin-zinc alloy layer and the zinc layer is 0.5 mg/cm²or more and 7.0 mg/cm²or less, and
a content per unit area of zinc is 0.07 mg/cm² or more and 2.0 mg/cm² or less.

6. The corrosion-resistant terminal material for an aluminum core wire according to claim 1, wherein
the corrosion-resistant film is provided on a part of the base material and a first film is provided on a part where the corrosion-resistant film is not provided,
the first film has the intermediate alloy layer and a first tin layer made of tin or tin alloy having a different composition from the intermediate alloy layer formed on the inter mediate alloy layer, and
the corrosion-resistant film does not have the first tin layer on the intermediate alloy layer.

7. A corrosion-resistant terminal for an aluminum core wire made of the corrosion-resistant terminal material for an aluminum core wire according to claim 1.

8. An electric wire terminal structure wherein the corrosion-resistant terminal for an aluminum core wire according to claim 7 is crimped to a terminal of an electric wire made of aluminum or aluminum alloy.

9. A method for manufacturing a corrosion-resistant terminal material according to claim 1, comprising
a first film forming step by laminating a plurality of plating layers on a base material in which at least a surface is made of copper or copper alloy and subjected to an alloying step, forming a first film having an intermediate alloy layer made of tin alloy and a first tin layer made of tin or tin alloy having a different composition from the intermediate alloy layer,
a tin layer removal step removing the first tin layer in the first film, and
a corrosion-resistant film forming step forming a zinc layer made of zinc or zinc alloy and a second tin layer made of tin or tin alloy in order on the intermediate alloy layer after the first tin layer is removed.

10. The method for manufacturing a corrosion-resistant terminal material for an aluminum core wire according to claim 9, wherein the intermediate alloy layer is a copper-tin alloy layer.

11. The method for manufacturing a corrosion-resistant terminal material for an aluminum core wire according to claim 9, wherein the intermediate alloy layer is a nickel-tin alloy layer.

12. The method for manufacturing a corrosion-resistant terminal material for an aluminum core wire according to claim 9, wherein in the tin layer removal step, a part of the first tin layer is removed, and a surface of a part where the first tin layer is not removed is maintained in a state in which a surface of the first film is exposed.
